(19) United States
(12) Patent Application Publication
(10) Pub. No.: US 2016/0119171 A1
(43) Pub. Date: Apr. 28, 2016

(54) System and Method for Wireless Communication Using Space-Time Block Code Encoding

(71) Applicants: Jung Hoon SUH, Kanata (CA); Osama ABOUL-MAGD, Kanata (CA)

(72) Inventors: Jung Hoon SUH, Kanata (CA); Osama ABOUL-MAGD, Kanata (CA)

(73) Assignee: Huawei Technologies Co., Ltd., Shenzhen (CN)

(21) Appl. No.: 14/875,111

(22) Filed: Oct. 5, 2015

Related U.S. Application Data
(60) Provisional application No. 62/069,632, filed on Oct. 28, 2014.

(51) Int. Cl. H04L 27/26; H04L 25/02

(52) U.S. Cl. CPC H04L 27/2602; H04L 25/0232; H04W 84/12

(57) ABSTRACT

An embodiment provides a method for wireless communications including an access point (AP) space-time block code (STBC) encoding a high efficiency wireless local area network (WLAN) (HEW) signal A (SIGA) fields, and transmitting a preamble comprising a duplicate stream portion including a repeated legacy long training field, and comprising a two-stream portion including the STBC-encoded HEW SIGA fields. In further embodiments, the method includes the duplicate stream portion including a pair of SIG-LTFs (or alternatively a compressed SIG-LTF) which is used for channel estimation and auto-detection.

### CROSS-REFERENCE TO RELATED APPLICATION(S)

This application claims priority to U.S. Provisional Patent Application No. 62/069,632 entitled “System and Method for Utilizing Lone Training Field and Space-Time Block Code-Based Signal Field” filed Oct. 28, 2014, the entire contents of which are incorporated herein by reference. This application is also related to U.S. Provisional Patent Application No. 62/062,004 entitled “Space-Time Block Code-Based Signal Field Systems and Methods” filed Oct. 9, 2014 (hereafter referred to as [1]), and to U.S. Provisional Patent Application No. 62/001,394 entitled “System and Method for Utilizing Unused Tones in Tone-Interleaved Long Training Field” filed May 21, 2014 (hereafter referred to as [2]), the entire contents of which are incorporated herein by reference. This application is also related to U.S. patent application Ser. No. 13/771,356 entitled “Dual-Stream Signal (SIG) Field Encoding with Higher Order Modulation” filed on Feb. 20, 2013, the entire contents of which are incorporated herein by reference.

### TECHNICAL FIELD

This invention relates to wireless transmission systems and methods, and more particularly to systems and methods which utilize space time block encoding (STBC).

### BACKGROUND

Institute of Electrical and Electronics Engineers (IEEE) standards publication 802.11 outlines protocols for implementing wireless local area networks (WLAN), and sets forth a physical (PHY) layer frame format that includes a preamble portion carrying control information and a payload portion carrying data. The preamble portion may include a variety of preamble fields, including a legacy short training field (LSTF), a legacy long training field (LLTF), and a legacy signal (LSIG) field. There have been various extensions to the 802.11 standards, for example, for providing a High Efficiency WLAN (HEW). Such HEW systems include HEW headers and can have different frame formats to allow for more advanced features (e.g., higher throughput, outdoor channels and multiple streams). However, there is a need for systems and frame formats to be backward compatible with legacy nodes which follow older versions of the standards.

It has been proposed to encode the data portion for a packet using two streams in accordance with a space-time block code (STBC) encoding scheme.

### SUMMARY

Aspects of this disclosure are directed to STBC encoding of HEW signal (HEW SIG) preamble information as well as to the data portion of the frame, and in particular to STBC encoding of at least one Signal Long Training Field (SIG-LTF) field included to facilitate both channel estimation and auto-detection by the receiver of the frame.

An aspect of the disclosure provides a method for wireless communications including an access point (AP) STBC encoding at least one SIG-LTF field encoded to facilitate both receiver channel estimation and auto-detection of the remainder of the frame and at least two high efficiency wireless local area network (HEW) signal (SIG) fields. The method further comprises transmitting a preamble comprising a two-stream portion. The two-stream portion includes and said STBC-encoded fields. In further embodiments, the method includes the two-stream portion including a pair of SIG-LTFs (or alternatively a compressed SIG-LTF) which is used for channel estimation and auto-detection. Further embodiments have the HEW-SIG fields including a pair of HEW-SIGA fields or both HEW-SIGA and HEW-SIGB fields. In an embodiment the HEW-SIGA carries control signaling information for all the stations (STAs) in a BSS (Basic Service Set) network. The HEW-SIGB carries control signaling information for the destination STAs, that is, information for the scheduled STAs from an AP.

An aspect of the disclosure provides a method for wireless communications including a receiver receiving a packet from an access point (AP) with a preamble comprising a space-time block code (STBC) encoded two-stream portion including at least one SIG-Long Training Field (SIG-LTF) field and high efficiency wireless local area network (HEW) signal (SIG) fields. The receiver performs channel estimation utilizing information encoded in the at least one SIG-LTF. The receiver further performs auto-detection of the packet by utilizing information encoded in the at least one SIG LTF.

Another aspect of the disclosure provides an Access Point (AP) for transmitting a wireless frame. Such an AP comprises M transmit antennas, a framer and an STBC encoder. The framer produces frame preamble data, said frame including a preamble comprising a legacy portion including legacy fields, and a multi-stream portion including at least one SIG-LTF field encoded to facilitate both receiver channel estimation and auto-detection of the remainder of the frame, and at least two HEW-SIG fields. The STBC encoder maps the multi-stream portion onto N streams and includes a Q_{M×N} matrix for mapping the N streams onto the M antennas for transmission.

Another aspect provides a receiver for receiving a space-time block code (STBC) encoded wireless frame. Such a receiver includes receive circuitry for receiving an STBC encoded signal including N streams on R receive antennas, a channel estimator for performing channel estimation utilizing the at least one SIG-LTF field, and an auto-detector for auto-detecting the frame utilizing the at least one SIG-LTF field.

The foregoing and other objects, features, aspects and advantages of the present invention will become more apparent from the following detailed description, taken in conjunction with the accompanying drawings, of exemplary embodiments of the invention, which description is by way of example only.

### BRIEF DESCRIPTION OF DRAWINGS

FIG. 1 illustrates a generalized preamble format, according to an embodiment;

FIG. 2 illustrates another frame format, according to an embodiment;

FIG. 3 illustrates another frame format, according to an embodiment;

FIG. 4 illustrates another frame format, according to an embodiment;

FIG. 5 illustrates a frame format according to an embodiment which is similar to that shown in FIG. 2, but which includes n HEW-SIGB fields;

FIG. 6 illustrates a frame format according to an embodiment which is similar to so that shown in FIG. 3, but which includes n HEW-SIGB fields;

FIG. 7 illustrates a frame format according to an embodiment which is similar to that shown in FIG. 4, but which includes n HEW-SIGB fields;

FIG. 8 is a table illustrating STBC encoding with one spatial-stream and two space-time streams, according to an embodiment;

FIG. 9 is a block diagram of a transmitter, according to an embodiment;

FIG. 10 is a block diagram of a receiver, according to an embodiment.

### DESCRIPTION OF EXEMPLARY EMBODIMENTS

The structure, manufacture and use of exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Various embodiments provide a space-time block code (STBC) preamble portion for a high efficiency WLAN (HEW), and in particular High Efficiency Signal (HEW-SIG) fields. An embodiment STBC-based preamble design provides both diversity gain in the outdoor channel and backward compatibility for legacy devices. As stated, there are currently a variety of extensions to 802.11 WLAN systems, with more extensions being developed. Accordingly, there are a variety of frame formats and encoding and transmission schemes (e.g., multiple streams) which may be utilized. Accordingly, a receiver needs to quickly determine this information (a process called auto-detection) in order to properly receive and decode the transmission.

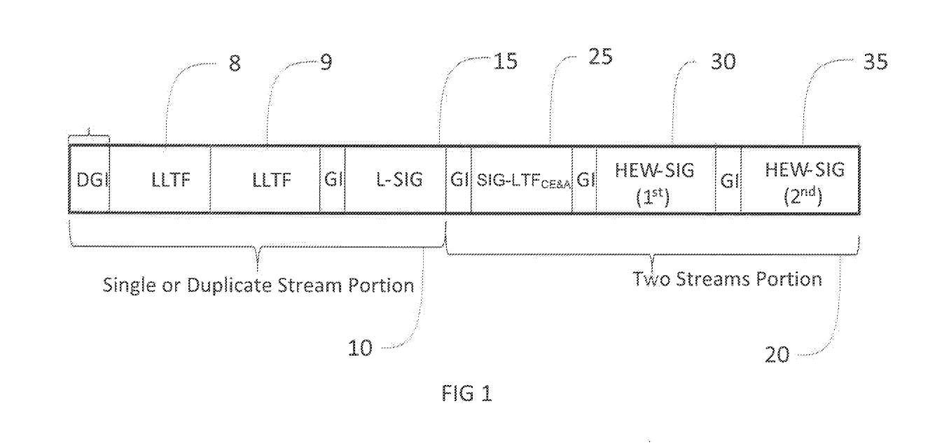

FIG. 1 illustrates a generalized preamble format, according to an embodiment. FIG. 1 includes a legacy portion 10, which can be transmitted in either single or duplicate streams, including LLTFs 8 and 9, and an L-SIG field 15. The frame also includes an STBC portion 20, which can be transmitted as two (or more) streams, including at least one STBC based long training field design (labeled as SIG-LTF_{CE&A}) which encodes information to be used by the receiver for both Channel Estimation and Auto-detection of the remainder of the frame. The STBC portion also includes a pair of HEW-SIG fields (HEW-SIG (1^{st}) 30 and HEW-SIG (2^{nd}) 35. It should be noted that in order to focus our discussion on the portions of the frame which are significant for channel estimation and auto-detection, not all the fields in a HEW frame are included. For example, an 802.11 frame can include additional fields which are not shown, including an LSTF. Further, although only one pair of HEW-SIG fields is shown, other embodiments can include additional pairs of HEW-SIG fields.

It should be appreciated that the generalized frame format illustrated in FIG. 1 is generalized as it does not include specific timing or symbol information, as the “fields” of this figure can comprise one or more fields depending on the embodiment. In particular, the SIG-LTF_{CA&A} and HEW-SIG fields can take various forms, as will be discussed in more detail below.

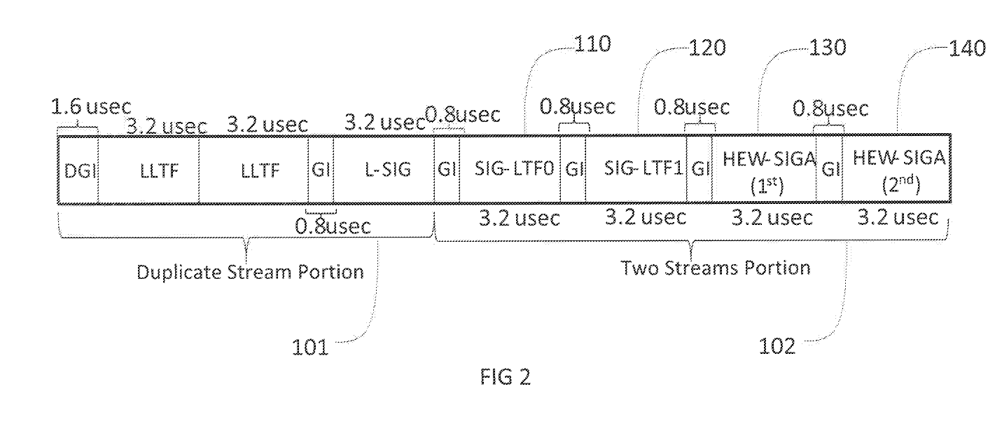

FIG. 2 illustrates a first frame format, according to an embodiment, including a duplicate stream portion 101 which includes the legacy fields, and a two stream portion 102 which is STBC encoded. The duplicate stream portion includes one set of preamble data which is duplicated on two streams when the frame is transmitted. The two stream portion is STBC encoded so each of the two streams includes different data due to the STBC encoding. In this embodiment, the SIG-LTF_{CE&A} field comprises two SIG-LTF fields, namely SIG-LTF0 110 and SIG-LTF1 120. The HEW-SIG frame comprises a pair of symbols, HEW-SIGA (1^{st}) 130 and HEW-SIGA (2^{nd}) 140. Each field is considered to be a symbol lasting 3.2 μsec, and between each symbol is a guard interval (GI) lasting 0.8 μsec.

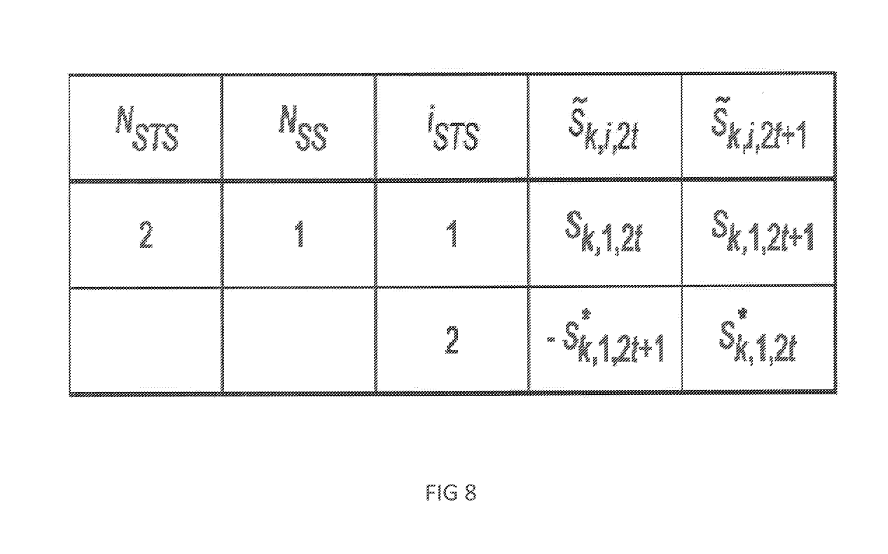

Since STBC is applied for the HEW-SIGA fields, channel estimation for the two streams is performed. The STBC encoding method follows the 802.11 specification. The table in FIG. 8 illustrates the STBC encoding with one spatial-stream and two space-time stream cases, according to an embodiment, where N_{STS} is the number of space-time streams, N_{SS} is the number of spatial-streams, and i_{STS} represents the index of space-time stream. In this embodiment, \tilde{S}_{k,i,2t} and \tilde{S}_{k,i,2t+1} represent the HEW-SIGA (1^{st}) symbol and the HEW-SIGA (2^{nd}) symbol at the k^{th} tone, respectively. The subscripts k, i, and t represent a tone, a spatial stream, and a time (symbol) index, respectively.

The two reference signal symbols, SIG-LTF0 and SIG-LTF1 precede the HEW-SIGA to provide for channel estimation of the two streams. According to embodiments, the SIG-LTF0 and SIG-LTF1 may be encoded with P-matrix based LTFs or Tone Interleaved LTFs (TILs), but the design method of LTFs is not limited to only those two methods, and other methods which provide for both channel estimation and auto-detection by the receiver can be used.

According to an embodiment, the P-matrix based LTFs may be encoded similarly to the methodology utilized in 802.11 ac, using the P-matrix to map tones from the long training sequence (LTS). To re-illustrate:

[SIG-LTF0ₖ,SIG-LTF1ₖ]_{N}_{_{TX}}_{×2}=QₖD_{CDD}^{(k)}P_{2×2}sₖ

where:

$${P}_{2 \times 2} = [ \begin{matrix}1 & - 1 \\ 1 & 1\end{matrix} ] , {s}_{k} \text{:}$$

LTS in tone k, and Qₖ is a spatial mapping matrix between 2 streams and N_{TX} with omni-directional beam.
D_{CDD}^{(k)} is a diagonal CDD phase shift matrix in tone k, of size 2×2,
where CDD is cyclic delay diversity
N_{TX} represents the number of TX antennas.

Another embodiment may re-use the LLTF for the two stream channel estimation. In this case, the P-matrix based LTFs will be encoded with LLTF and SIG-LTF using the same equation as illustrated above. That is, a single SIG-LTF symbol is utilized instead of the two SIG-LTF symbols (SIG-LTF0 and SIG-LTF1) in FIG. 2. In such an embodiment, the LLTF field and the SIG-LTF field are used to encode the P-matrix based LTFs.

As stated, another embodiment utilizes a TIL based SIG-LTF design. An example of an LTF design using TIL for the multi-stream channel estimation was illustrated in [2]. The same long training sequence (LTS) as the 802.11 LTS may be re-used for the TIL, but it should be appreciated that other LTSs can be used. An embodiment of a receiver receives a signal which re-uses the LTS from the HT-LTF/VHT-LTF of 802.11n/ac estimates 56 out of 64 FFT tones per symbol. An embodiment which utilizes the LTS from the LLTF leads to a receiver estimation of 52 out of 64 tones per 20 MHz WLAN symbol. Not all of the tones need be estimated as guard tones and nulls need not be estimated. Embodiments which re-use the LTS from the HT-LTF or VHT-LTF utilize 52 data tones, excluding the pilot tones, for each HEW-SIGA symbol, whereas embodiments which use the LTS from the LLTF utilize 48 data tones per HEW-SIGA symbol.

In one embodiment, for whichever LTS might be used for the TIL design, the even-number indexed sequences of LTS will be mapped to the reference sequence of the first stream, and the odd-number indexed sequence of LTS will be mapped to the reference sequence of the second stream in the case of SIG-LTF0. The SIG-LTF1 symbol will use the opposite LTS mapping for the two streams. That is to say, the even-number indexed sequence of LTS will be mapped to the reference sequence of the second stream for the SIG-LTF1 symbol and the odd-number indexed sequence of LTS will be mapped to the reference sequence of the first stream for SIG-LTF1.

However, this mapping is not necessary provided the indexed sequences of the LTS are alternately mapped between the SIG-LTFs (SIG-LTF0 and SIG-LTF1). Accordingly, in other embodiments the mapping of the even- and odd-number indexed sequence of LTS may be swapped and reversed between SIG-LTF0 and SIG-LTF1.

SIG-LTF0 and SIG-LTF1 are used to estimate the 2×2 Multiple Input Multiple Output (MIMO) channels for embodiments in which the destination receiver has 2 RX antennas. Accordingly, the channel for the two symbols, SIG-LTF0 and SIG-LTF1, can be equalized after channel estimation is completed using those two SIG-LTF symbols.

An auto-detection procedure, according to an embodiment, will now be discussed. The estimated channel parameter per tone and per channel is complex conjugated and then multiplied with the received signals at each receive (RX) antenna for channel equalization purposes. As the subcarriers are alternately mapped with each stream, the subcarriers at the receiver are fully mapped on all the tones. Further, the received subcarriers are the same between the two TIL symbols. Hence, after the channel equalization has been completed, the system can perform auto-detection by adding the received signals at each receive antenna and cross correlating the two TIL symbols. The auto-detection is completed based on the correlation results exceeding a certain threshold or not.

Alternatively, the system can add the received signals at each RX and add the two TIL symbols on a tone-by-tone basis. In this case, the system then determines the average energy of the real part of this sum for the received signal and the average energy of the imaginary part of this sum for the received signal. Auto-detection is then determined by comparing the difference between those two averages with a threshold.

A similar auto-detection procedure can be applied for embodiments which utilize the P-matrix based SIG-LTF0 and SIG-LTF1 fields. The 2×2 MIMO channel equalization can be performed for signals using the P-matrix based LTFs as was discussed above. Further, the same energy detection method as was described in the paragraph above can be used for auto-detection of a signal using the P-matrix based SIG-LTF0 and SIG-LTF1 fields.

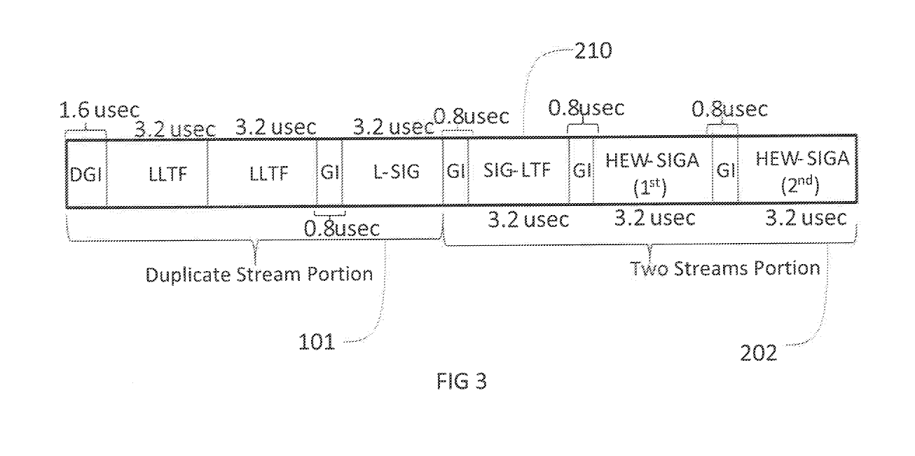

FIG. 3 illustrates an alternative embodiment, which utilizes a single compressed SIG-LTF 210 for SIG-LTF_{CE&A}. In one embodiment, the SIG-LTF0 and SIG-LTF1 discussed above with reference to FIG. 2 can be compressed to form SIG-LTF 210, which is a single symbol. In this case, interpolation between tones is utilized (for auto-detection). This field can be P-matrix encoded or represent a TIL. It is noted there may be some benefits for using the TIL based SIG-LTF0 and SIG-LTF1 design in terms of running the interpolation at the RX side to recover the two stream channel. However, the compression is not limited to the TIL and may be applied to P-matrix based LTFs as well.

It is noted that simulations indicate that the channel estimation performance using this compressed SIG-LTF may be degraded from the non-compressed LTF by about 1 dB. Nonetheless, the STBC based preamble achieves sufficient diversity gain (about 4 dB using the same number of receiving antennas as compared to earlier 802.11 systems) that embodiments using such an STBC preamble with the compressed LTF can still be utilized for outdoor channels for many applications.

The compressed SIG-LTF 201 is still encoded with information which can be used for both channel estimation and auto-detection. In an embodiment, the receiver interpolates between the tones of the compressed SIG-LTF, such that the received tones are considered even, and the interpolated tones are considered odd, such that channel estimation and auto-detection can be performed as described above.

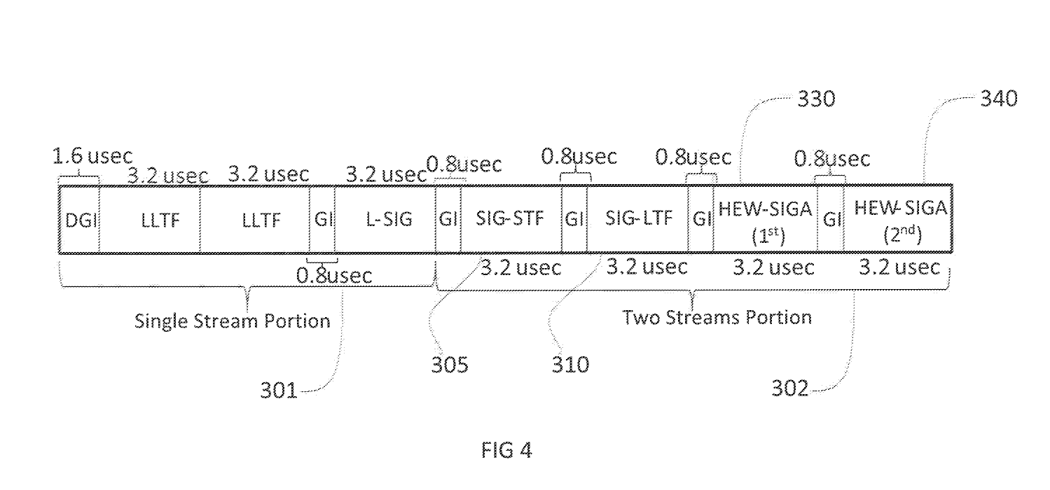

FIG. 4 illustrates a frame including a two stream portion using STBC encoding a pair of HEW-SIGA fields according to another embodiment. As stated above, not all the fields in an HEW frame are included. In this embodiment, the frame is illustrated to include a single stream portion 301 and a two-stream portion 302. In this embodiment, the frame includes a two stream portion comprising a single SIG-LTF frame 310 preceding the HEW-SIGA (1st) 330 and HEW-SIGA (2nd) 340 fields. Preceding the SIG-LTF frame is a SIG-STF frame 305. The SIG-STF is included to provide automatic gain control for the two stream portion.

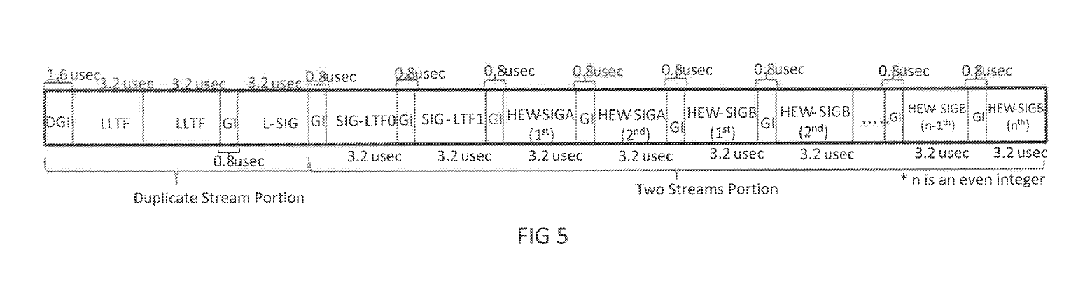

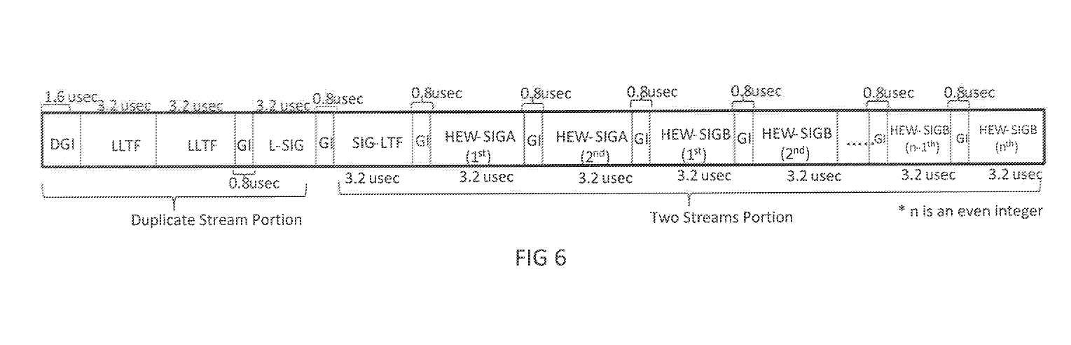

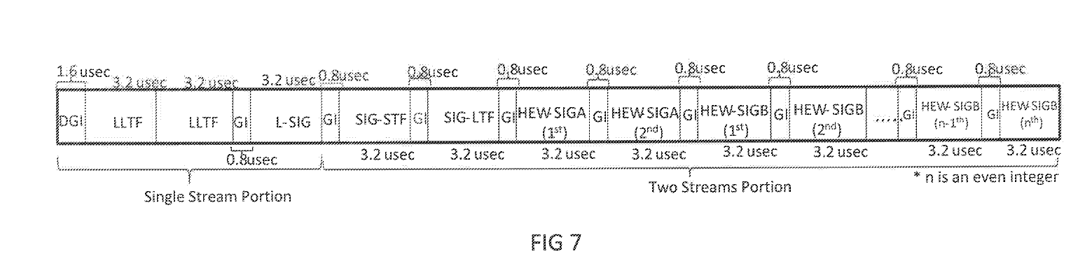

It is envisioned that additional HEW-SIG fields may be needed to provide more information for more advanced features and throughput. Accordingly, embodiments include HEW-SIGB field as well as HEW-SIGA fields as part of the two stream portion of the frame (i.e., they undergo STBC encoding). FIG. 5 illustrates a frame format according to an embodiment which is similar to that shown in FIG. 2, but which includes n HEW-SIGB fields, where n is an even integer. FIG. 6 illustrates a frame format according to an embodiment which is similar to that shown in FIG. 3, but which includes n HEW-SIGB fields, where n is an even integer. FIG. 7 illustrates a frame format according to an embodiment which is similar to that shown in FIG. 4, but which includes n HEW-SIGB fields, where n is an even integer.

It should be appreciated that each of these frame formats have been illustrated assuming the system utilized two streams. It should be appreciated that a larger number of streams N can be used. In such a case, the multi-stream portion should include N SIG-LTF fields for channel estimation. However, the number of SIG-LTF fields can be larger than N in order to provide redundancy. Further the number of transmit antennas need not be N. A system can utilize M transmit antennas, and the transmitter maps the N streams onto the M antennas using a M×N beamforming matrix, for the example an 802.11 Q_{M×N} Matrix. Further, it should be appreciated that a receiver need not use the same number of antennas (R) as the transmitter. Indeed, the receiver does not need to know the number of transmit antennas M, but rather only needs to decode the N streams for a R×N MIMO system.

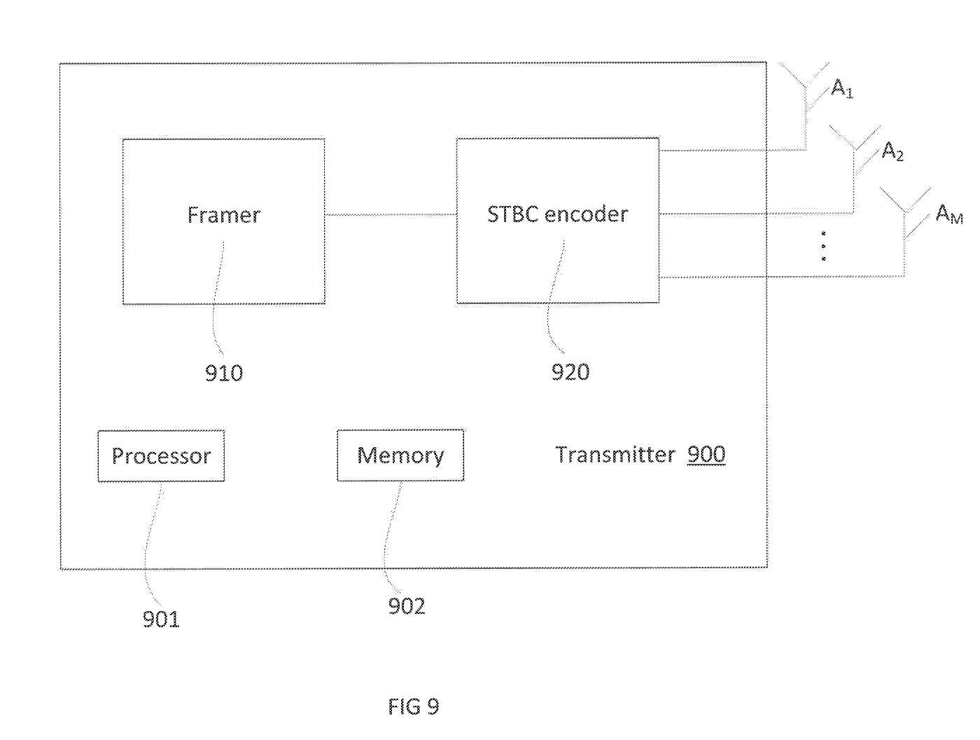

FIG. 9 is block diagrams of a transmitter having M transmit antennas, according to an embodiment. Such a transmitter may form part of an Access Point (AP). FIG. 9 includes a transmitter 900 coupled to M transmit antennas A₁, A₂ . . . A_{M}. The transmitter includes a framer 910 for producing frame preamble data for a packet (or frame) as discussed herein. For example, the framer 910 produces a frame with a preamble comprising a legacy portion including legacy fields, and a multi-stream portion including at least one SIG-LTF field encoded to facilitate both receiver channel estimation and auto-detection of the remainder of the frame, and at least two high efficiency wireless local area network (HEW) signal (SIG) fields. The transmitter 900 also includes a space-time block code (STBC) encoder 920 for mapping said multi-stream portion onto N streams, said STBC encoder including a Q_{M×N} matrix for mapping said N streams onto said M antennas for transmission. The framer 910 and STBC encoder 920 may be implemented by one or more processors 901 and associated memory 902. The processors may include FPGAs, ASICs, general purpose micro-processors or the like. It should be appreciated that there are other components of the transmitter circuitry which are not germane to the present disclosure, and are therefore not shown.

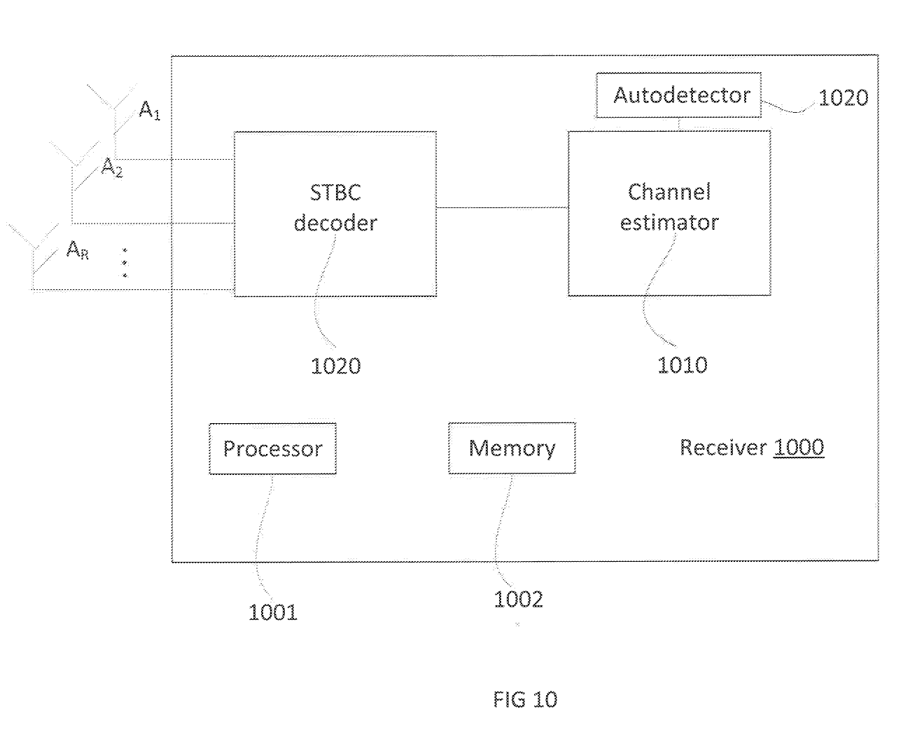

FIG. 10 is block diagrams of a receiver having R receive antennas A₁, A₂ . . . A_{R}, according to an embodiment. Such a receiver may form part of a user station (STA). The receiver includes a space-time block code (STBC) decoder 1020 for receiving the N transmitted STBC encoded streams on the R receive antennas. The receiver includes a channel estimator 1010 for performing channel estimation utilizing the at least one SIG-LTF field (for example SIG-LTF0 and SIG-LTF1) and an auto-detector 1020 for auto-detecting said frame utilizing said at least one SIG-LTF, as described above.

The channel estimator 1010 and an auto-detector 1020 may be implemented by one or more processors 1001 and associated memory 1002. The processors may include FPGAs, ASICs, general purpose micro-processors or the like. It should be appreciated that there are other components of the receiver circuitry which are not germane to the present disclosure, and are therefore not shown.

Embodiments may be implemented in WLAN systems and devices, such as APs, STAs, processor chips, and machine readable mediums for storing machine readable instructions for causing a processor to execute the methods described and claimed herein, and the like.

Although embodiments of the invention have been described and illustrated in detail, it is to be clearly understood that the same is by way of illustration and example only and not to be taken by way of limitation, the scope of the present invention being limited only by the appended claims.

1. A method for wireless communications by an access point (AP) comprising:
space-time block code (STBC) encoding:
at least one Signal Long Training Field (SIG-LTF) field encoded to facilitate both receiver channel estimation and auto-detection of the remainder of the frame, and
at least two high efficiency wireless local area network (HEW) signal (SIG) fields; and
transmitting a packet with a preamble comprising a two-stream portion including the STBC-encoded fields.

2. The method as claimed in claim 1, wherein said at least two HEW-SIG fields comprise at least two HEW-SIGA fields.

3. The method as claimed in claim 2 wherein said at least two HEW-SIG fields further comprise at least two HEW-SIGB fields.

4. The method as claimed in claim 3 wherein said at least two HEW-SIGB fields comprise a plurality of pairs of HEW-SIGB fields.

5. The method as claimed in claim 1 wherein said AP includes at least two antennas, and wherein said STBC encoding step comprises mapping said two stream portion to said at least two antennas.

6. The method as claimed in claim 1, wherein said preamble includes a legacy portion including legacy fields and wherein said transmitting step comprises transmitting said legacy portion using a single stream, and then transmitting each of said two stream portions, wherein said two stream portions further comprise a SIG-STF frame for automatic gain control.

7. The method as claimed in claim 1 wherein said preamble includes a legacy portion including legacy fields and wherein said legacy portion is duplicated during transmission such that each of said two stream portions is preceded by said legacy portion

8. The method as claimed in claim 1 wherein said at least one SIG-LTF field comprises a pair of SIG-LTFs preceding the HEW-SIG fields.

9. The method as claimed in claim 8 wherein said pair of SIG-LTFs are Tone Interleaved LTFs (TIL) or wherein said pair of SIG-LTFs are P-matrix encoded.

10. A method for wireless communications comprising:
receiving a packet from an access point (AP) with a preamble comprising a space-time block code (STBC) encoded two-stream portion including at least one SIG-Long Training Field (SIG-LTF) field and high efficiency wireless local area network (HEW) signal (SIG) fields;
performing channel estimation utilizing information encoded in said at least one SIG-LTF; and
performing auto-detection of said packet by utilizing information encoded in said at least one SIG LTF.

11. The method as claimed in claim 10 wherein said at least one SIG-LTF comprises a pair of SIG-LTFs and wherein performing auto-detection comprises cross correlating the pair of SIG LTF symbols.

12. The method as claimed in claim 10 said at least one SIG-LTF comprises a pair of SIG-LTFs and wherein performing auto-detection of said packet comprises:
cross-correlating the pair of SIG-LTFs on a per tone basis;
contrasting with a threshold.

13. The method as claimed in claim 10 wherein said at least one SIG-LTF comprises a single SIG-LTF, and wherein the method further comprises performing channel estimation at a receiver of said transmitted frame by interpolating between tones of said single SIG-LTF.

14. The method as claimed in claim 13, wherein auto-detection of said packet at a receiver of said packet comprises:
adding the received signals at each receive antenna per each tone after the channel equalization;
estimating the energy detection of each real and imaginary part per tone;
comparing the averaged energy detection over all the tones with a threshold.

15. An Access Point for transmitting a wireless frame comprising:
M transmit antennas;
a framer for producing frame preamble data, said frame including a preamble comprising a legacy portion including legacy fields, and a multi-stream portion including at least one SIG-LTF field encoded to facilitate both receiver channel estimation and auto-detection of the remainder of the frame, and at least two high efficiency wireless local area network (HEW) signal (SIG) fields; and
a space-time block code (STBC) encoder for mapping said multi-stream portion onto N streams, said STBC encoder including a Q_{M×N} matrix for mapping said N streams onto said M antennas for transmission.

16. An Access Point as claimed in claim 15 wherein said framer includes a P-matrix encoder for producing a pair of SIG-LTF fields.

17. An Access Point as claimed in claim 15 wherein said framer includes a tone interleaver for producing a pair of tone interleaved SIG-LTF fields.

18. An Access Point as claimed in claim 15 further comprising a processor and machine readable memory including executable instructions for implementing said framer and said STBC encoder.

19. An Access Point as claimed in claim 15 wherein said multi-stream portion is a two stream portion such that N=2, and wherein said high efficiency wireless local area network (HEW) signal (SIG) fields comprise at least two HEW-SIGA fields and at least two HEW-SIGB fields.

20. A receiver for receiving a space-time block code (STBC) encoded wireless frame comprising:
receive circuitry for receiving an STBC encoded signal including N streams on R receive antennas; said STBC encoded signal including a frame including a preamble comprising a legacy portion including legacy fields, and a multi-stream portion including at least one SIG-LTF field encoded to facilitate both receiver channel estimation and auto-detection of the remainder of the frame, and at least two high efficiency wireless local area network (HEW) signal (SIG) fields;
a channel estimator for performing channel estimation utilizing said at least one SIG-LTF field; and
an auto-detector for auto-detecting said frame utilizing said at least one SIG-LTF field.
